(19) United States
(12) Patent Application Publication
(10) Pub. No.: US 2010/0291929 A1
(43) Pub. Date: Nov. 18, 2010

(54) PHYSICAL-LAYER CELL IDENTIFICATION IN A COMMUNICATION SYSTEM

(75) Inventors: Paul M. Stephens, Swindon (GB); Simon C. Brusch, Faringdon (GB); Luis Lopes, Swindon (GB); John Mathews, Swindon (GB); Chris M. Murphy, Bath (GB)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/465,982

(22) Filed: May 14, 2009

(51) Int. Cl. H04W 36/00

(52) U.S. Cl. 455/436

(57) ABSTRACT

A system and method for physical cell identification in a wireless communication system includes a first step 500 of providing a set of temporary physical cell identifications for cells. A next step 502 includes identifying a new cell in the communication system. A next step 506 includes allocating a temporary physical cell identification for the new cell. A next step 510 includes changing the temporary physical cell identification of the new cell to a permanent physical cell identification.

### FIELD OF THE INVENTION

The invention relates to wireless communication systems, and in particular to physical-layer cell identification in a communication system.

### BACKGROUND OF THE INVENTION

Currently 3^{rd} generation (3G) cellular communication systems based on Code Division Multiple Access (CDMA) technology, such as the Universal Mobile Telecommunication System (UMTS), are being deployed, and 4^{th} generation (4G) communication systems such as Worldwide Interoperability for Microwave Access (WiMAX) and Long Term Evolution (LTE) are being planned. In the 4G LTE system, cells are identified both by a global cell identification similar to the Global System for Mobile (GSM) Cell ID as is presently used, and also a short form called the Physical-layer Cell ID (PCI). User equipment (UE) in idle mode only sees the PCI. UEs in active mode only report the PCI of neighbours unless specifically asked by the serving cell to get the global cell identification. The problem with the PCI is that it has a cardinality of 504, and therefore careful planning is required to ensure that there is no identity confusion when reporting neighbouring cells. Therefore, the problem with cell PCI is very similar to that faced in GSM frequency and macro base station identity code (BSIC) planning, except that there are more PCIs to choose from, and adjacent PCIs do not pose a problem. In currently deployed 3G communication systems, each cell has a relatively low number of neighbours, and therefore UEs receive a neighbour list identifying a relatively small number of PCIs of neighbour cells as potential handover targets. Extending the current approach to 4G scenarios where a UE may need to consider large numbers of neighbouring cells is not practical.

The problem of extending current approaches to scenarios where there are many cells is how to uniquely and efficiently identify a cell. Specifically, it is not practically feasible to assign individual pilot signal scrambling codes or frequency/base station identity combinations to each cell and to identify all potential handover cells, including femto-cells, as neighbours of the cell as this would require very large neighbour lists. These large neighbour lists would result in the neighbour list exceeding the maximum allowable number of neighbours in the list. It would furthermore require significant operations and management resource in order to configure each cell with the large number of neighbours and would complicate network management, planning and optimisation. It would also increase the size of the configuration database and significantly increase the number of configuration change notifications sent around the network. In addition, the sharing of PCIs of the cells results in a target ambiguity and prevents the mobile station from uniquely identifying a potential handover target. For example, if a group of base stations supporting different cells use an identical PCI, a mobile station detecting the presence of this shared PCI will be aware that a potential handover target has been detected but will not be able to uniquely identify and report which of the cells has been detected. Although The UE can be asked to resolve a PCI uncertainty by fetching the eCGI of the Cell with that PCI, the use of this procedure should be minimised as it places additional load on the UE.

Solutions to this problem currently utilize centralised radio frequency planning tools for frequency planning and managing cell identifications. However, this is difficult to implement due to the nature of 4G cells that can appear and disappear from the network quite rapidly and in large numbers. These solutions are also expensive in that these tools all require substantial interaction by planners and operators, as the plan is initially created in an external model of the network, and this model needs to be kept up to date with the real sites on the ground.

Therefore, what is needed is a PCI planning process that is removed from a centralized function that requires extensive planner/operator interaction. It would be of further benefit if cells could have the ability to self plan in whatever order they are deployed.

### BRIEF DESCRIPTION OF THE DRAWINGS

The invention is pointed out with particularity in the appended claims. However, other features of the invention will become more apparent and the invention will be best understood by referring to the following detailed description in conjunction with the accompanying drawings in which:

FIG. 1 illustrates an example of a communication system in accordance with the present invention;

FIG. 2 illustrates an example of a call flow for a first embodiment of the present invention;

FIG. 3 illustrates an example of a call flow for a second embodiment of the present invention;

FIG. 4 illustrates an example of a call flow for a third embodiment of the present invention; and

FIG. 5 illustrates an example of a method, in accordance with some embodiments of the invention.

Skilled artisans will appreciate that common but well-understood elements that are useful or necessary in a commercially feasible embodiment are typically not depicted or described in order to facilitate a less obstructed view of these various embodiments of the present invention.

### DETAILED DESCRIPTION OF EMBODIMENTS OF THE INVENTION

The present invention enables a distributed PCI planning process that removes a purely centralized control function that requires extensive planner/operator interaction. In particular, the present invention enables a distributed self organizing network (SON) that manages PCI allocations to new cell sites by only allowing one cell to make PCI changes at any one time and combining this with the allocation of temporary PCIs. In this way, cells have the ability to self plan in whatever order they are deployed.

The following description focuses on embodiments of the invention applicable to 4G communication systems such as LTE and WiMAX. For example, the present invention can be implemented for LTE Evolved NodeBs (eNB) or LTE centralised-SON where the functionality is lightweight enough so that it could be hosted on an element management system (EMS) for small networks. Alternatively, each eNB could host the functionality of the present invention. The present invention could also be applied to the WiMAX Basestation ID. However, it will be appreciated that the invention is not limited to these applications but may be applied to many other cellular communication systems such as a 3GPP (Third Generation Partnership Project) E-UTRA (Evolutionary UMTS Terrestrial Radio Access) standard, a 3GPP2 (Third Generation Partnership Project 2) Evolution communication system, a CDMA (Code Division Multiple Access) 2000 1XEV-DV communication system, a Wireless Local Area Network (WLAN) communication system as described by the IEEE (Institute of Electrical and Electronics Engineers) 802.xx standards, for example, the 802.11a/HiperLAN2, 802.11g, 802.16x, or 802.21 standards, or any of multiple other proposed ultrawideband (UWB) communication systems.

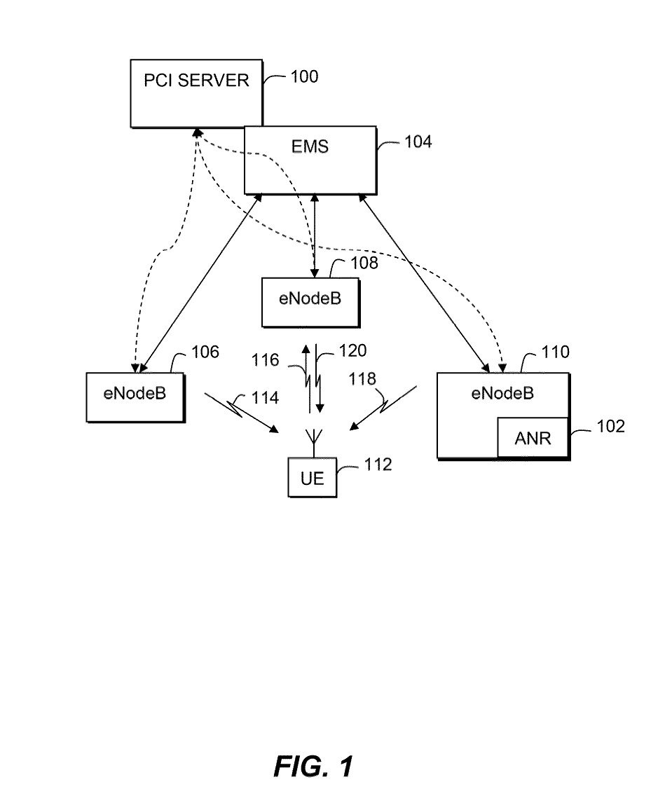

FIG. 1 illustrates an example of a cellular communication system, which in the specific example is a 4G LTE communication system. In the system, a communication layer is formed by macro-cells supported by base stations as is known in the art. The communication system can includes multiple user equipment (UE) 112 (one shown), such as but not limited to a cellular telephone, a radio telephone, a personal digital assistant (PDA) with radio frequency (RF) capabilities, or a wireless modem that provides RF access to digital terminal equipment (DTE) such as a laptop computer. Furthermore, the communication layer of cells are supported by a large number of base stations each of which henceforth will be referred to as an evolved NodeB (eNB). Such eNBs can include wireless access points, NodeBs, Home NodeBs, or other type of wireless base stations, for example. As used herein, the term “cell” can refer to individual cell sites or different sectors within a cell site.

The eNBs provide communication services to each UE residing in its coverage area, such as a cell of a 4G radio access network, via a wireless communication interface. Each eNB includes a transceiver or a Base Transceiver Station (BTS), in wireless communication with each UE and further may include functionality similar to a Radio Network Controller (RNC) or Base Station Controller (BSC), coupled to the transceiver. The transceiver and controller can each includes a respective processor, such as one or more microprocessors, microcontrollers, digital signal processors (DSPs), combinations thereof or such other devices known to those having ordinary skill in the art. The particular operations/functions of processors, and respectively thus of the transceiver and controller, are determined by an execution of software instructions and routines that are stored in a respective at least one memory device, as are known in the art, associated with the processor, such as random access memory (RAM), dynamic random access memory (DRAM), and/or read only memory (ROM) or equivalents thereof, that store data and programs that may be executed by the corresponding processor.

The UE also includes a processor, such as one or more microprocessors, microcontrollers, digital signal processors (DSPs), combinations thereof or such other devices known to those having ordinary skill in the art. The particular operations/functions of the processor, and respectively thus of UE, is determined by an execution of software instructions and routines that are stored in a respective at least one memory device associated with the processor, such as random access memory (RAM), dynamic random access memory (DRAM), and/or read only memory (ROM) or equivalents thereof as are known in the art, that store data and programs that may be executed by the corresponding processor. The UE also has the processor coupled to a transceiver for communicating over the air interface with the eNB.

Under the control of one eNB 108, the UE 112 can periodically obtain the PCIs 114, 118 from its neighbouring eNBs 106, 110 (only two shown in this example). The UE 100 will then report 116 these PCIs to its serving eNB(s). Each eNodeB contains an Automatic Neighbour Relationship (ANR) module 102 (only shown in 110 for example). In accordance with the present invention, a PCI server is provided, wherein the PCI server can be a separate entity or part of the EMS 104 or other network entity. Alternatively, the temporary PCI function can be contained within each eNB.

In the communication system, the eNBs should each have a Physical Cell Identification (PCI) that is unique within a given region. The PCI may be reused in other areas as long a UE in one area cannot access a cell in the other area having the same PCI. Specifically, each eNB has an assigned PCI which is unique within the reuse area such that a set of defined neighbours for each cell always have different PCIs. Each UE is provided a neighbour list of neighbouring eNBs.

In operation, in the system of FIG. 1, a UE 112 is initially being served by a serving eNB 108. The UE 112 reads 114, 118 the PCIs of its neighbouring eNBs 106, 110 of the neighbour list. The UE 112 then generates a measurement report which is transmitted 116 from the UE 112 to the eNB 108. Although this is straightforward in fixed communication systems, 4G cells can be added, moved, or removed quite easily, making identification of neighbouring cells problematic.

The present invention addresses this issue by enabling distributed PCI allocation through the use of a centralised PCI function, in the form of a PCI server 100, to control the use of temporary PCIs used in accordance with the present invention. The present invention also avoids confusion that could arise through the use of temporary PCIs by only allowing one cell at a time to make a PCI change. The PCI server 100 can be used for both the allocation of a PCI to newly installed cells or to send the list of permanent PCIs to the e Node B to enable the allocation of a new permanent PCI where network topology changes have caused a PCI clash, requiring a PCI change to an existing cell.

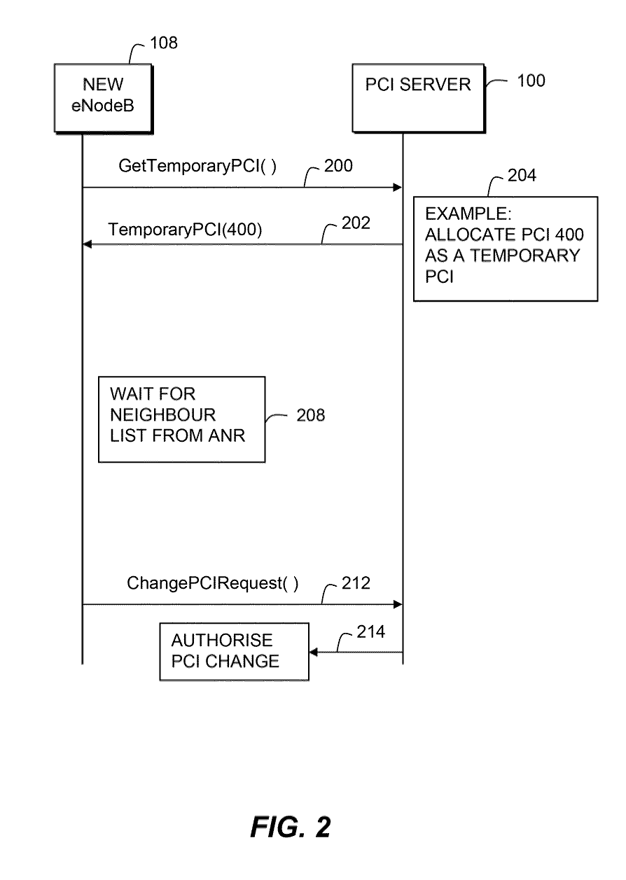

Referring to FIG. 2, the PCI server 100 holds a pool of temporary PCIs. The temporary PCIs are provided such that there is no conflict with any existing permanent PCIs of cells. When a new cell comes online its eNB 108 will request 200 a temporary PCI from the PCI server 100, which can be contained in a separate network entity, or even in the eNB itself. The PCI server 100 selects 204 one of the unused temporary PCIs, in this example “400”, and will not provide the same temporary PCI to any other requesting cell until the new cell completes its change to a permanent PCI. If eNBs self-assign temporary PCI, then these temporary PCIs as assigned on a random basis reducing the likelihood that two new cells next to each other will assign the same temporary PCI at the same time.

The temporary PCI is then allocated to the new cell, such as through message 202. Optionally, the message may also include an ANR-settling time, such as 12 Hours for example, which is a recommendation to the new cell to not attempt to calculate a new permanent PCI until that settling time has elapsed 208. In effect, the temporary PCI is leased to the new cell for the settling time. Alternatively, the settling time, also known as convergence, could be determined by a count of the number of connections received since initialisation or similar method. The purpose of this convergence time is to allow the ANR module of the eNB to assemble all of the neighbours of the new cell in a neighbour list to be provided 208 to the new cell.

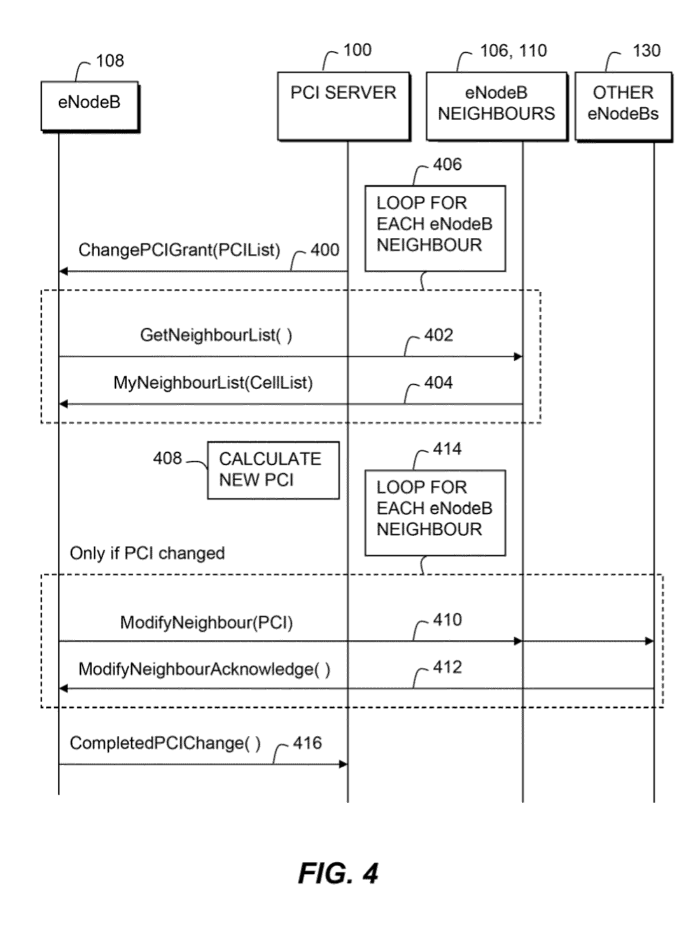

When a cell wants to calculate a new PCI it shall make a ChangePCIRequest 212 to the PCI server 100. All requests from cells will be queued in a first-in first-out (FIFO) type queue. When a ChangePCIRequest reaches the front of the queue a ChangePCIGrant message 214 is sent authorising the new cell to start the permanent PCI change procedure of FIG. 4.

FIG. 4 refers to the process for a cell to select a permanent PCI. Firstly, the ChangePCIGrant message 400 (214 from FIG. 1) from the PCI server 100 shall contain a list (PCIList) of all the permanent PCIs which the cell 108 may choose from. Only one outstanding ChangePCIGrant message will be allowed in the network so there is no possibility of multiple concurrent changes, which could result in poor PCI selection. Upon receiving the ChangePCIGrant message 400, the cell 108 will proceed to contact the neighbours 106, 110 in its neighbour list from the ANR in a neighbour update message (GetNeighbourList( ) 402) that requests each neighbouring cell 106, 110, in turn 406, to provide their neighbour list to the cell 108. Each neighbour cell 106, 110, in turn 406, acknowledges the request 402 by providing their own neighbour list (MyNeighbourList(CellList) 404). In effect, the cell builds a list of all its neighbours PCIs and their lists of their neighbours PCIs. The cell 108 can then calculate 408 a permanent PCI (from the PCIList of 400) that is not duplicated by any of its neighbours or neighbours' neighbours PCIs. In particular, the cell 108 shall select for itself the lowest numerical PCI or a random PCI, from the total list of allowed PCIs that is not used in the cell 108, neighbours 106, 110 in its neighbour list, and neighbours of its neighbours.

If a unique PCI cannot be found, then the Cell shall select a PCI that is not in its direct neighbor list, and is least used within its neighbor of neighbor list.

Once the cell 108 has calculated 408 its permanent PCI, it then sends its new permanent PCI in a ModifyNeighbour(PCI) message 410 to each of the neighbours 106, 110 in its neighbour list as well other eNodeBs 130 in which the eNB 108 is listed as a neighbor, in turn 414, so that its neighbours can modify their neighbour list with the new permanent PCI of the cell 108. Each neighbour cell 106, 110, 130 must then modify its neighbour list, and the cell 108 should wait for all the neighbours in its neighbour list to acknowledge the change with a ModifyNeighbourAcknowledge( ) message 412, in turn 414. The cell 108 can then send a CompletedPCIChange message 416 to the PCI server 100. This message allows the temporary PCI to be returned to the pool and other cells in the network may select permanent PCIs.

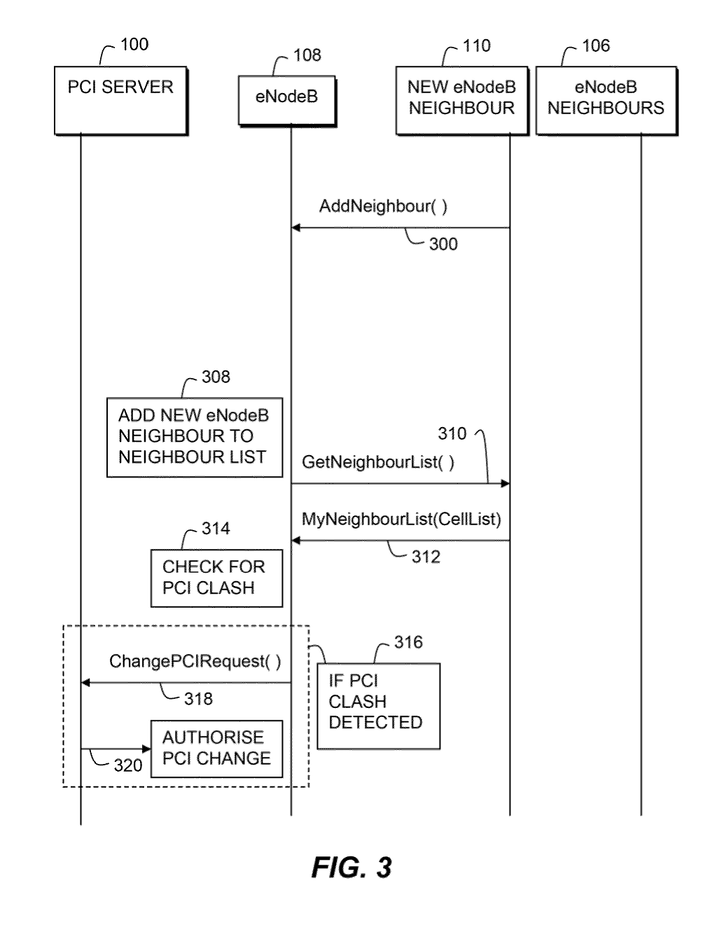

Referring to FIG. 3, the present invention also addresses PCI conflicts that can occur when an existing cell 108 has a new neighbour cell 110 added to its communication network. When a cell 108 receives an indication (i.e. AddNeighbour( ) message 300) that a new neighbour cell has been added to the network, then the cell 108 should check for a PCI clash. The cell 108 shall send a GetNeighbourList( ) request to all of its existing neighbours in it's neighbour list, in turn, and build a neighbour of neighbour list from the cell list in each MyNeighbourList(CellList) message received in turn. The cell 108 will also add the new neighbour 110 to in neighbour list and send a GetNeighbourList( ) request 310 to the new neighbour 110 in order to receive it's neighbour list MyNeighbourList(CellList) 312. Alternatively, This data exchange could operate as follows: Whenever a change occurs in a first cell's neighbour list, the updated configuration of that neighbour list is sent to all cells that see that first cell as a neighbour. Each cell must then maintain a persistent list of its neighbors of neighbors, as the current standards do not provide a way to “pull” this information on demand.

If the cell has the same PCI as the new neighbour 110 or a neighbour of an exiting neighbour 106, then it has recognised that there is a PCI clash 314. If the cell 108 recognizes a clash 316 within the neighbour list of another cell, then it should send a ChangePCIRequest( ) message 318 to the PCI server 100, which will then authorize 320 a PCI change in accordance with the same procedures previously described above for FIG. 4.

In an optional embodiment, where each sector in a new cell site will need a permanent PCI, the above procedures are performed for each sector individually. In particular, the eNB will ask for a temporary PCI for each of its sectors. The PCI server assigns a set of orthogonal temporary PCIs for the sectors. After convergence, permanent PCIs are assigned as described above. The permanent PCI is assigned from a configured Permanent Pool derived from the 504 available PCIs, which consists of separate groups of PCIs, where PCIs from different groups will be more orthogonal to PCIs in the same group. In addition, selection of the PCIs from different groups may result in advantageous situations such the frequency offsets that will be used for the reference signals or pilot symbols for example. Therefore, the first sector will be assigned a permanent PCI from a any orthogonal group of PCIs. The second sector will be assigned a permanent PCI from a different orthogonal group of PCIs than was used for the first sector. Similarly, the third sector will be assigned a permanent PCI from a different orthogonal group of PCIs than was used for the first and second sectors. In this way, the sectors within a site will have permanent PCIs that have greater orthogonality to each other and will improve the ability of the UEs to decode the reference signal for example. Preferably, the sectors can select a random PCI from its particular group list of allowed PCIs. In a synchronised system such as a TDD system, the chosen PCI may be selected such that configurations where the PCI groups of the chosen PCI and the PCI groups of nearby cells coincide, are minimized, or otherwise optimised.

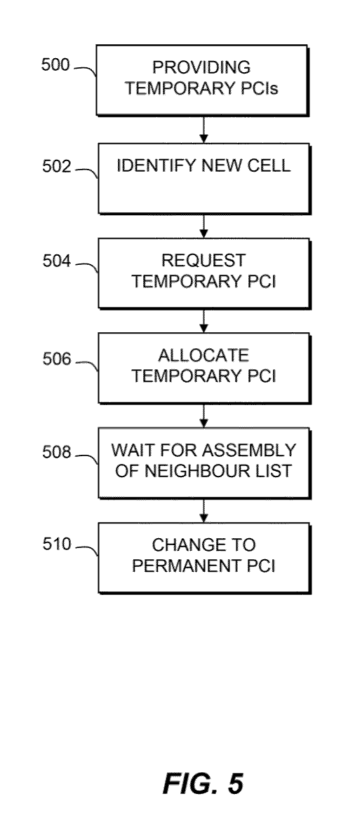

FIG. 5 illustrates an example of method for physical cell identification in a wireless communication system. The method initiates in step 500 of providing a set of temporary physical cell identifications for cells.

The method includes a next step 502 of identifying a new cell in the communication system. The identification can be of a new neighbouring cell by an existing cell or by a new cell itself.

The method includes a next step 504 of requesting a temporary physical cell identification. Preferably, the requests are granted in a first-in first-out manner.

The method includes a next step 506 of allocating a temporary physical cell identification for the new cell. Preferably, this step allocates each temporary PCI value to at most one cell at a time until the changing step 510 is completed. If there are multiple requests from the requesting step 504, allocations are performed on a first-in first-out basis.

The method includes a next step 508 of waiting until a convergence criteria has been achieved so that a neighbour list can be assembled and provided to the new cell. The convergence criteria can include a convergence threshold, or can simply be a predetermined time limit.

The method includes a next step 510 of changing the temporary physical cell identification of the new cell to a permanent physical cell identification. This step 510 includes multiple substeps of: a) authorising a PCI change, b) obtaining physical cell identifications of neighbouring cells of the cell, c) obtaining physical cell identifications of neighbouring cells of the neighbouring cells, d) selecting a lowest numerical physical cell identification from a list of available physical cell identifications that is not being used by any of the cell, neighbouring cells, and neighbours of the neighbouring cells, and e) completing the PCI change. This step 510 can also includes the substeps of: sending the selected physical cell identification from the selecting substep to each of the neighbouring cells, modifying the neighbour list of each of the neighbouring cells with the selected physical cell identification, and receiving an acknowledgement from each of the neighbouring cells.

In the case where the new cell from the identifying step 502 is a new neighbour cell, the changing step 510 includes the substeps of: obtaining physical cell identifications of the new cell and the neighbouring cells of the cell, obtaining physical cell identifications of neighbouring cells of the new cell and the neighbouring cells, checking to see if any the physical cell identifications are the same as the physical cell identification of the cell, and requesting a new physical cell identification for the cell.

Advantageously, the present invention provides a technique for cells to self-determine their own physical cell identifications, thereby eliminating the need for a central network entity to assign physical cell identifications. In addition, the present invention only allows one cell to make PCI changes at any one time and combines this with the allocation of temporary PCIs. In this way, cells have the ability to self plan in whatever order they are deployed. Using one temporary server for the network also guarantees complete uniqueness in temporary PCI assignment in the network where no duplicate temporary PCI can exist in the network at the same time.

The sequences and methods shown and described herein can be carried out in a different order than those described. The particular sequences, functions, and operations depicted in the drawings are merely illustrative of one or more embodiments of the invention, and other implementations will be apparent to those of ordinary skill in the art. The drawings are intended to illustrate various implementations of the invention that can be understood and appropriately carried out by those of ordinary skill in the art. Any arrangement, which is calculated to achieve the same purpose, may be substituted for the specific embodiments shown.

The invention can be implemented in any suitable form including hardware, software, firmware or any combination of these. The invention may optionally be implemented partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate.

Furthermore, the order of features in the claims do not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, “an”, “first”, “second” etc do not preclude a plurality.

What is claimed is:

1. A method for physical-layer cell identification in a wireless communication system, the method comprising the steps of:
providing a set of temporary physical cell identifications for cells;
identifying a new cell in the communication system;
allocating a temporary physical cell identification for the new cell; and
changing the temporary physical cell identification of the new cell to a permanent physical cell identification.

2. The method of claim 1, wherein this step allocates a temporary PCI value to at most one cell at a time until the changing step is complete.

3. The method of claim 1, wherein before the changing step, further comprising a step of waiting a convergence criteria has been achieved so that a neighbour list can be assembled and provided to the new cell.

4. The method of claim 1, wherein the changing step includes the substeps of:
obtaining physical cell identifications of neighbouring cells of the cell;
obtaining physical cell identifications of neighbouring cells of the neighbouring cells; and
selecting a physical cell identification from a list of available physical cell identifications that is not being used by any of the cell, neighbouring cells, and neighbours of the neighbouring cells.

5. The method of claim 4, further comprising the substeps of:
authorising a PCI change, and
completing the PCI change.

6. The method of claim 4, wherein the selecting substep includes selecting the lowest numerical physical cell identification that is not being used.

7. The method of claim 4, further comprising the substeps of:
sending the selected physical cell identification from the selecting substep to each of the neighbouring cells,
modifying the neighbour list of each of the neighbouring cells with the selected physical cell identification, and
receiving an acknowledgement from each of the neighbouring cells.

8. The method of claim 1, wherein the identifying step includes identifying a new neighbour cell, and wherein the changing step includes the substeps of:
obtaining physical cell identifications of the new cell and the neighbouring cells of the cell;
obtaining physical cell identifications of neighbouring cells of the new cell and the neighbouring cells;
checking to see if any the physical cell identifications are the same as the physical cell identification of the cell; and
requesting a new physical cell identification for the cell.

9. The method of claim 1, further comprising the step of requesting a temporary physical cell identification, wherein the requests are granted in a first-in first-out manner.

10. The method of claim 1, wherein the changing step includes assigning a sector of a site a physical cell identification that is more orthogonal to the physical cell identification of other sectors at that site.

11. A method for physical-layer cell identification in a wireless communication system, the method comprising the steps of:
providing a set of temporary physical cell identifications for cells;
identifying a new cell in the communication system;
requesting a temporary physical cell identification;
allocating a temporary physical cell identification for the new cell; and
waiting until a convergence criteria is met such that a neighbour list can be assembled and provided to the new cell;
changing the temporary physical cell identification of the new cell to a permanent physical cell identification.

12. The method of claim 11, wherein the allocating step includes allocating a temporary PCI value to at most one cell at a time until the changing step is complete.

13. The method of claim 11, wherein the changing step includes the substeps of:
obtaining physical cell identifications of neighbouring cells of the cell;
obtaining physical cell identifications of neighbouring cells of the neighbouring cells; and
selecting a physical cell identification from a list of available physical cell identifications that is not being used by any of the cell, neighbouring cells, and neighbours of the neighbouring cells.

14. The method of claim 13, further comprising the substeps of:
sending the selected physical cell identification from the selecting substep to each of the neighbouring cells,
modifying the neighbour list of each of the neighbouring cells with the selected physical cell identification, and
receiving an acknowledgement from each of the neighbouring cells.

15. The method of claim 11, wherein the identifying step includes identifying a new neighbour cell, and wherein the changing step includes the substeps of:
obtaining physical cell identifications of the new cell and the neighbouring cells of the cell;
obtaining physical cell identifications of neighbouring cells of the new cell and the neighbouring cells;
checking to see if any the physical cell identifications are the same as the physical cell identification of the cell; and
requesting a new physical cell identification for the cell.

16. The method of claim 11, wherein the changing step includes assigning a sector of a site a physical cell identification that is more orthogonal to the physical cell identification of other sectors at that site.

17. A system for physical-layer cell identification in a wireless communication system, the system comprising:
a temporary physical cell identification server configurable with a set of temporary physical cell identifications to be allocated to new cells, and
a new cell in the communication system, the new cell operable to receive an allocated temporary physical cell identification and change the temporary physical cell identification of the new cell to a permanent physical cell identification.
